(19) United States
(12) Patent Application Publication
(10) Pub. No.: US 2025/0277467 A1
(43) Pub. Date: Sep. 4, 2025

(54) SENSOR CARRYING SUBASSEMBLY AND AN EXHAUST SYSTEM INCORPORATING THE SENSOR CARRYING SUBASSEMBLY

(71) Applicant: Purem GmbH, Neunkirchen (DE)

(72) Inventors: Bernhard Reyer, Altbach (DE); Christian Schäfer, Unterensingen (DE); Frank Reinhardt, Püttlingen (DE)

(21) Appl. No.: 19/070,237

(22) Filed: Mar. 4, 2025

(30) Foreign Application Priority Data
Mar. 4, 2024 (DE) 10 2024 106 105.7

(51) Int. Cl. F01N 13/00; G01M 15/10

(52) U.S. Cl. CPC F01N 13/008; G01M 15/102

(57) ABSTRACT

A sensor carrying subassembly includes a sensor carrying member having a wall. A wall opening surrounded at an outer wall side by an outer wall surface is provided in the wall and a sensor connecting piece secured to the outer wall surface in the region of the wall opening. In the sensor connecting piece a sensor receiving opening is provided extending through the sensor connecting piece in the direction of a sensor receiving opening longitudinal axis from a distal axial end, positioned remote from the wall, of the sensor connecting piece to a proximal axial end, positioned near the wall, of the sensor connecting piece and open relative to the wall opening. In the region of the proximal axial end of the sensor connecting piece a sensor connecting piece connection face is provided annularly surrounding the sensor receiving opening and angled with respect to the sensor receiving opening longitudinal axis.

### CROSS-REFERENCE TO RELATED APPLICATIONS

This application claims priority of German patent application no. 10 2024 106 105.7, filed Mar. 4, 2024, the entire content of which is incorporated herein by reference.

### TECHNICAL FIELD

The present disclosure relates to a sensor carrying subassembly which can be used, for example, to attach a measurement sensor, such as, for example, a temperature sensor or gas sensor, to an exhaust system of an internal combustion engine.

### BACKGROUND

US 2020/0271546 discloses a sensor carrying subassembly, in which a sensor connecting piece is connected to an outer side of a wall of an exhaust gas guiding component in a materially engaging manner by a weld seam, or is integrally configured with the wall. A receiving opening for receiving a measurement sensor is formed in a sensor carrying insert which is inserted in the sensor connecting piece.

### SUMMARY

An object of the present disclosure is to provide a structurally simply configured sensor carrying subassembly which is resistant to thermomechanical loads.

This object is, for example, achieved according to the disclosure by a sensor carrying subassembly, in particular for an exhaust system of an internal combustion engine, including:
a sensor carrying member having a wall, wherein a wall opening which is surrounded at an outer wall side by an outer wall surface is provided in the wall,
a sensor connecting piece which is secured to the outer wall surface in the region of the wall opening, wherein there is provided in the sensor connecting piece a sensor receiving opening which extends through the sensor connecting piece in the direction of a sensor receiving opening longitudinal axis from a distal axial end, which is positioned remote from the wall, of the sensor connecting piece to a proximal axial end, which is positioned near the wall, of the sensor connecting piece,
wherein there is provided in the region of the proximal axial end of the sensor connecting piece a sensor connecting piece connection face, which annularly surrounds the sensor receiving opening and which is angled with respect to the sensor receiving opening longitudinal axis, with radial spacing which decreases in the direction away from the distal axial end of the sensor connecting piece from the sensor receiving opening longitudinal axis, wherein the sensor connecting piece is secured to the wall by connection material which is connected to the sensor connecting piece connection face and a connection portion of the outer wall surface.

By providing the sensor connecting piece connection face which is in the form of a chamfering, material is removed from the sensor connecting piece and replaced by the connection material. Since the connection material, similarly to the construction material of the wall, is generally ferritic material while the sensor connecting piece may be constructed, for example, with austenitic material, the material proportion of ferritic material can be increased with a reduced requirement for structural space with the structure according to the disclosure, whereby in the region of the connection of the sensor connecting piece to the wall an increased connection strength can also be achieved in view of the different thermal expansion behaviors of these two members.

For a defined positioning, the sensor connecting piece can abut the wall with a wall abutment face which is formed in the region of the proximal axial end.

In order to be able to use the sensor connecting piece connection face to the maximum extent for connecting the connection material, it is proposed that a substantially axially orientated sensor connecting piece front face which extends substantially orthogonally relative to the sensor receiving opening longitudinal axis and which annularly surrounds the sensor receiving opening longitudinal axis adjoin the sensor connecting piece connection face, and that the sensor connecting piece front face provide the wall abutment face.

In this case, the precise orientation of the sensor connecting piece with respect to the wall opening can be supported simply by a centering attachment which extends axially beyond the sensor connecting piece front face and which is surrounded by the sensor connecting piece front face being provided on the sensor connecting piece in the region of the proximal axial end.

In a compact configuration which is structurally simple to implement, the sensor connecting piece connection face can provide the wall abutment face.

Here too the precise orientation of the sensor connecting piece can be supported with respect to the wall opening if a centering attachment which adjoins the sensor connecting piece connection face, extends axially beyond the sensor connecting piece connection face and is surrounded by the sensor connecting piece connection face is provided on the sensor connecting piece in the region of the second front side.

The sensor connecting piece connection face which tapers in the axial direction can be configured, for example, in a substantially conical manner.

For a thermally and chemically resistant connection, it is proposed that the connection material be provided by a weld seam.

Since particularly components which guide exhaust gas in exhaust systems are configured in a generally tubular manner, that is, have curved walls, it is proposed that a connection plate be formed on the wall in the region of the wall opening, wherein the connection portion, which surrounds the wall opening, is orientated in the direction of a wall opening center axis and extends substantially orthogonally to the wall opening center axis, of the outer wall surface is provided on the connection plate.

In order to provide sufficient space for introducing the connection material or to be able to introduce the connection material in a defined manner over the entire circumference, it is proposed that the connection plate be formed on the wall by forming the wall in the direction toward the outer wall side and in the direction away from an inner space which is delimited by the wall.

In order to be able to provide the connection plate with a sufficiently great surface for stable connection of the sensor connecting piece to the wall, it is proposed that the connection plate be formed by drawing, preferably deep-drawing or stretch-drawing, the wall.

For a stable connection of the sensor connecting piece to the connection plate, there may be provision for the connection portion of the outer wall surface to overlap the sensor connecting piece connection face at least partially radially and to extend radially outwardly beyond a preferably substantially cylindrical outer circumferential face of the sensor connecting piece, and for the connection material to extend radially outwardly beyond the outer circumferential face of the sensor connecting piece.

The disclosure further relates to a method for producing a sensor carrying subassembly with the structure described above, in which method the connection plate is formed by drawing, preferably deep-drawing or stretch-drawing, the wall.

The disclosure further relates to an exhaust system, in particular for an internal combustion engine in a vehicle, including at least one sensor carrying subassembly constructed according to the disclosure.

In this case, the wall can delimit an exhaust gas flow space in the exhaust system, wherein the outer wall side is orientated away from the exhaust gas flow space and a measurement sensor is carried on the sensor connecting piece.

The measurement sensor may be configured, for example, to provide information which represents a temperature in the region of the exhaust gas flow space or to provide information which represents a composition of exhaust gas flowing through the exhaust gas flow space.

### BRIEF DESCRIPTION OF DRAWINGS

The invention will now be described with reference to the drawings wherein:

FIG. 1 shows a schematic illustration of a portion of an exhaust system;

FIG. 2 shows a side view of a sensor connecting piece;

FIG. 3 shows the sensor connecting piece which is secured to a wall of a sensor carrying member of FIG. 2;

FIG. 4 shows a view, corresponding to FIG. 2, of an alternative embodiment of a sensor connecting piece; and,

FIG. 5 shows the sensor connecting piece, which is secured to a wall of a sensor carrying member, of FIG. 4.

### DETAILED DESCRIPTION

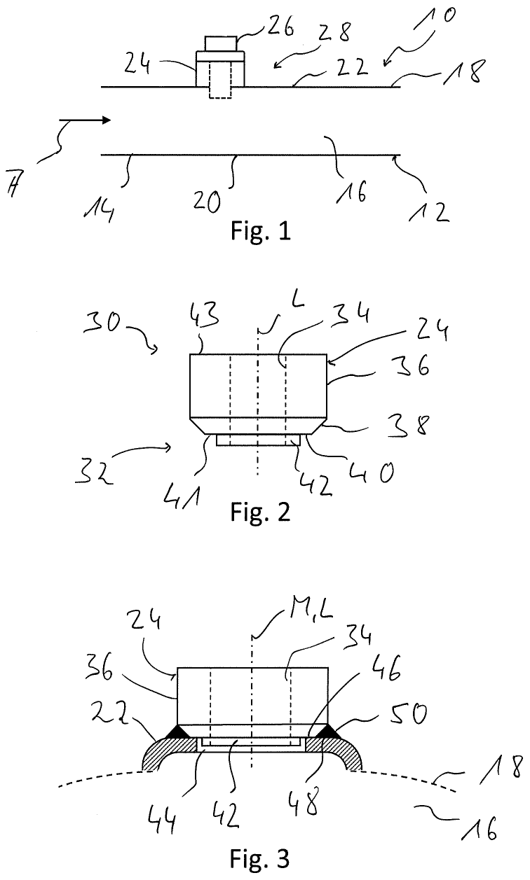

FIG. 1 illustrates a portion of an exhaust system 10 for an internal combustion engine, for example, in a vehicle. The exhaust system 10 includes an exhaust gas guiding component 12 which is configured, for example, in a tubular or housing-like manner and through which the exhaust gas A which is discharged from an internal combustion engine flows. The exhaust gas guiding component 12 forms a sensor carrying member 14 which is generally made from metal material, in particular sheet metal material, with a wall 18 which delimits the exhaust gas flow space 16, through which the exhaust gas A flows and which provides an inner space, of the exhaust gas guiding component 12. At an outer side 20 which is orientated away from the exhaust gas flow space 16, the wall 18 has an outer wall surface 22, to which a sensor connecting piece 24 which is described in detail below is secured. A measurement sensor 26, by which information which represents, for example, the temperature of the exhaust gas A which flows through the exhaust gas flow space 16, or which represents the chemical composition or the presence of a component of the exhaust gas A, can be provided, can be attached to the sensor connecting piece 24. Together with the sensor carrying member 14, the sensor connecting piece 24 forms a sensor carrying subassembly which is generally designated 28 for the measurement sensor 26.

The sensor connecting piece 24 illustrated in FIG. 2 has a distal axial end 30 which is positioned remote from the outer wall surface 22 of the wall 18 and a proximal axial end 32 which is positioned near the wall 18. A sensor receiving opening 34 which is indicated in FIG. 2 by broken lines extends between the distal axial end 30 and the proximal axial end 32 of the sensor connecting piece 24 along a sensor receiving opening longitudinal axis L. The sensor connecting piece 24 has an annular structure which surrounds the sensor receiving opening longitudinal axis L, for example, in a substantially rotationally symmetrical manner. In the region thereof surrounding the sensor receiving opening 34, the sensor connecting piece 24 may be formed with an inner thread, in which the measurement sensor 26 can be screwed with a complementary outer thread in order, on the one hand, to retain the measurement sensor 26 in a stable manner on the sensor connecting piece 24 and, on the other hand, to achieve a closure which is sealed to prevent the discharge of exhaust gas.

The sensor connecting piece 24 has an outer circumferential face 36 which is substantially cylindrical with respect to the sensor receiving opening longitudinal axis L, for example, with a circular cross-sectional contour which extends, for example, from the distal axial end 30 as far as the region of the proximal axial end 32 of the sensor connecting piece 24 and consequently over the greater axial extent region of the sensor connecting piece 24. A sensor connecting piece connection face 38 which tapers radially, for example, conically, in the direction away from the distal axial end 30 of the sensor connecting piece 24, adjoins the outer circumferential face 36 in the region of the proximal axial end 32. A sensor connecting piece front face 40 which annularly surrounds the sensor receiving opening longitudinal axis L, similarly to the sensor connecting piece connection face 38, and which is orientated in the direction of the sensor receiving opening longitudinal axis L adjoins the axial end region with the smallest radial dimension of the sensor connecting piece connection face 38. This means that the sensor connecting piece front face 40 extends from a radially inner side toward a radially outer side substantially orthogonally to the sensor receiving opening longitudinal axis. At the proximal axial end 32, the sensor connecting piece 24 further has a centering attachment 42 which is surrounded by the sensor connecting piece front face 40.

Consequently, the sensor connecting piece 24 can be subdivided substantially into three longitudinal portions. A longitudinal portion which extends from the distal axial end 30 is surrounded by the, for example, substantially cylindrical outer circumferential face 36 and provides at the distal axial end 30 a measurement sensor abutment face 43 which annularly surrounds the sensor receiving opening 34 and which extends radially and substantially orthogonally with respect to the sensor receiving opening longitudinal axis L. This longitudinal portion is adjoined by a longitudinal portion which substantially provides the sensor connecting piece connection face 38 and which tapers radially so as to correspond to the, for example, substantially conical structure of the sensor connecting piece connection face 38, against which longitudinal portion in turn the third longitudinal portion which substantially provides the centering attachment 42 adjoins.

The sensor connecting piece 24 which is made, for example, from austenitic metal material is secured to the wall 18 of the sensor carrying member 14, which is provided by the exhaust gas guiding component 12, in the manner illustrated in FIG. 3.

As illustrated in FIG. 3 by broken lines, the sensor carrying member 14 or the exhaust gas guiding component 12 generally has a curved cross-sectional geometry, for example, curved in a circular manner. In order to be able to connect the sensor connecting piece 24 to a cross-sectional geometry curved in this manner in the region of the proximal axial end 32 thereof in a stable and particularly also gas-tight manner, in the region of a wall opening 44 which is formed in the wall 18 the wall 18 is formed in the direction outward, that is, away from the exhaust gas flow space 16, in order to provide a connection plate 46, in which the outer wall surface 22 of the wall 18 is formed in a substantially non-curved manner, that is, so as to extend substantially orthogonally relative to a wall opening center axis M. In the region of this connection plate 46, a connection portion 48 of the outer surface 22 of the wall 18 in which the sensor connecting piece 24 is secured to the wall 18 by a connection material 50 is formed.

The connection material 50 which is preferably completely surrounded annularly by the wall opening 44 is preferably provided by a weld seam and is, on the one hand, connected to the construction material of the wall 18 in the region of the connection portion 48 thereof and, on the other hand, connected to the construction material of the sensor connecting piece 24 in the region of the sensor connecting piece connection face 38. Consequently, a stable and gas-tight, materially engaging connection is provided, wherein the sensor connecting piece 24 which is made, for example, from austenitic metal material is securely connected to the construction material, which is provided, for example, by ferritic metal material, of the wall 18. Since generally also the connection material 50 is provided as ferritic metal material, consequently, in the region of the connection of the sensor connecting piece 24 to the wall 18, on the one hand, as a result of the chamfering of the sensor connecting piece 24 in the region of the proximal axial end 32 in order to provide the sensor connecting piece connection face 38, the volume proportion of austenitic metal material is reduced and, on the other hand, the volume proportion of ferritic metal material is increased.

This leads to a very high connection stability even in the case of thermomechanical loads which occur during operation of an internal combustion engine as a result of different thermal expansions. In particular, a contribution is also made to this in that the connection portion 48 of the outer wall surface 22 completely radially overlaps the sensor connecting piece connection face 38 and, on the one hand, extends radially inwardly as far as the region of the sensor connecting piece front face 40 and consequently allows a defined planar support of the sensor connecting piece 24 on the wall 18, and, on the other hand, also extends at least slightly radially outwardly beyond the outer circumferential face 36 of the sensor connecting piece 24. The sensor connecting piece front face 40 consequently forms a wall abutment face 41, against which the sensor connecting piece 24 abuts the outer wall surface 22 of the wall 18 in the region of the connection plate 46. This allows the connection material 50 also to be introduced in such quantities that it, on the one hand, covers the entire sensor connecting piece connection face 38 and the portion, which radially overlaps therewith, of the connection portion 48 of the outer wall surface 22, and, on the other hand, extends radially outwardly beyond the outer circumferential face 36 of the sensor connecting piece 24, whereby the interacting face between the connection material 50 and the wall 18 has comparatively great dimensions. In the radially outer region thereof, the weld seam which provides the connection material 50 can extend, for example, as far as the convex-curved region, which adjoins the substantially non-curved connection portion 48 of the outer wall surface 22, of the wall 18 which is outwardly deformed for providing the connection plate 46, that is, beyond the non-curved connection portion 48.

In order to be able to form the wall 18 with simple technical means in order to provide the connection plate 46 which has sufficiently great dimensions, the wall 18 can be formed using corresponding forming tools in the region in which the wall opening 44 is formed or is intended to be formed, by drawing, in particular deep-drawing or stretch-drawing. This operation for forming the wall 18 can be carried out after the wall opening 44 has already been produced in the region in which the connection plate 46 is subsequently intended to be formed. In order to ensure that the cross-sectional geometry of the wall opening 44 is not changed during this forming operation, in an alternative procedure the wall opening 44 can be produced only after the wall 18 has been formed in order to produce the connection plate 46, for example, by punching or cutting out.

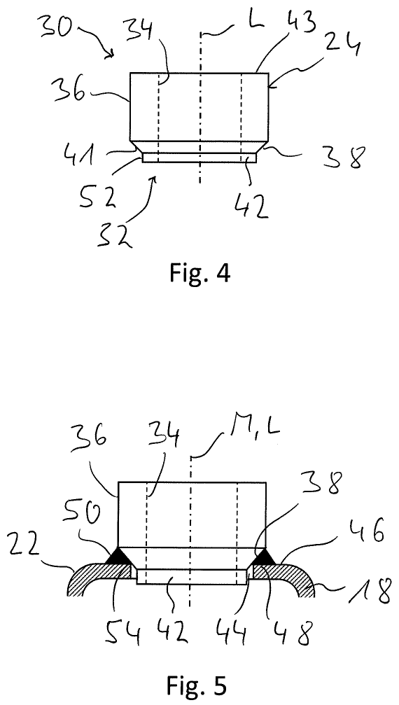

An alternative embodiment of the sensor connecting piece 24 is illustrated in FIG. 4. In this embodiment, the centering attachment 42 adjoins with the outer circumferential face 52 thereof which is, for example, cylindrical and which consequently extends substantially in the direction of the sensor receiving opening longitudinal axis L, directly against the sensor connecting piece connection face 38. The step-like transition which is provided in the embodiment of FIG. 2 by the sensor connecting piece front face 40 is not present in this embodiment.

When this sensor connecting piece 24 is connected to the outer surface 22 of the wall 18, the sensor connecting piece 24 is positioned with the sensor connecting piece connection face 38 thereof in abutment against an edge-like peripheral region 54, which surrounds the wall opening 44, of the wall 18. The sensor connecting piece connection face 38 consequently forms the wall abutment face with which the sensor connecting piece 24 adjoins the wall 18 in the region of the connection plate 46. In this case, there is substantially produced a linear abutment contact between the sensor connecting piece 24 and the wall 18, whereby, as a result of the contact face which is reduced in comparison with the embodiment of FIGS. 2 and 3 between the sensor connecting piece 24 and the wall 18, the thermal transmission to the sensor connecting piece 24 can be reduced.

In the embodiment, which is illustrated in FIGS. 4 and 5, of the sensor connecting piece 24, the connection portion 48 of the outer wall surface 22 does not completely cover the sensor connecting piece connection face 38 in the radial direction. For a high level of connection strength, however, it is advantageous if the connection portion 48 covers at least 50%, preferably at least 70%, of the radial extent of the sensor connecting piece connection face 38.

In the region, which is radially covered or overlapped by the connection portion 48, of the sensor connecting piece receiving face 38, the connection material 50 is connected to the sensor connecting piece connection face 38 and the connection portion 48 of the outer wall surface 22. In this embodiment, the connection material 50 also extends radially outwardly beyond the overlap region and therefore also the outer circumferential face 36 of the sensor connecting piece 24 in order to achieve an increased connection strength not only as a result of a comparatively large interacting face between the connection material 50 and the connection portion 48, but also a greater volume proportion of ferritic metal material in the region of the connection of the sensor connecting piece 24 to the wall 18.

The sensor carrying subassembly which is configured according to the disclosure and several of which can also be provided in one exhaust system ensures a stable connection, even under the thermal and mechanical loads which occur, as a result of the increase in the ferritic metal proportion with a reduced structural space requirement. As a result of the circumstance that, in a wall which is provided with a curved outer circumferential contour, the region, which is formed in order to provide the substantially planar connection plate, of the wall is deformed outwardly, that is, in the direction away from the exhaust gas flow edge which is delimited by the wall, there is good access to the region in which the materially engaging connection, in particular a weld connection, is intended to be produced by introducing the connection material between the sensor connecting piece connection face and the connection portion of the outer wall surface and in a state projecting radially outwardly beyond the outer circumferential face of the sensor connecting piece.

It is understood that the foregoing description is that of the preferred embodiments of the invention and that various changes and modifications may be made thereto without departing from the spirit and scope of the invention as defined in the appended claims.

1. A sensor carrying subassembly comprising:
a sensor carrying member having a wall defining an outer wall side and an outer wall surface;
said wall having a wall opening formed therein surrounded at said outer wall side by said outer wall surface;
a sensor connecting piece secured to said outer wall surface in a region of said wall opening;
said sensor connecting piece having a sensor receiving opening and defining a distal axial end disposed remote from said wall and a proximal axial end positioned near said wall;
said sensor receiving opening extending through said sensor connecting piece in a direction of a sensor receiving opening longitudinal axis from said distal axial end to said proximal axial end positioned near said wall;
a sensor connecting piece connection face being provided in a region of said proximal axial end of said sensor connecting piece;
said sensor connecting piece connection face annularly surrounding said sensor receiving opening and being angled with respect to said sensor receiving opening longitudinal axis with radial spacing decreasing in a direction away from said distal axial end of said sensor connecting piece from said sensor receiving opening longitudinal axis; and,
said sensor connecting piece being secured to said wall via connection material connected to said sensor connecting piece connection face and a connection portion of said outer wall surface.

2. The sensor carrying subassembly of claim 1, wherein said sensor connecting piece abuts said wall with a wall abutment face formed in the region of said proximal axial end.

3. The sensor carrying subassembly of claim 2, further comprising:
an axially orientated sensor connecting piece front face extending orthogonally relative to said sensor receiving opening longitudinal axis;
said axially orientated sensor connecting piece annularly surrounding said sensor receiving opening longitudinal axis and adjoining said sensor connecting piece connection face; and,
said sensor connecting piece front face providing said wall abutment face.

4. The sensor carrying subassembly of claim 3, further comprising a centering attachment extending axially beyond said sensor connecting piece front face and said centering attachment being surrounded by said sensor connecting piece front face and being provided on the sensor connecting piece in the region of said proximal axial end.

5. The sensor carrying subassembly of claim 2, wherein said sensor connecting piece connection face defines said wall abutment face.

6. The sensor carrying subassembly of claim 5, further comprising:
a centering attachment adjoining said sensor connecting piece connection face and extending axially beyond said sensor connecting piece connection face and being surrounded by said sensor connecting piece connection face and being provided on said sensor connecting piece in the region of said proximal axial end.

7. The sensor carrying subassembly of claim 1, wherein said sensor connecting piece connection face is configured in a conical manner.

8. The sensor carrying subassembly of claim 1, wherein said connection material is provided by a weld seam.

9. The sensor carrying subassembly of claim 1, further comprising:
a connection plate formed on said wall in the region of said wall opening; and,
said connection portion surrounding said wall opening and being orientated in the direction of a wall opening center axis and extending orthogonally to said wall opening center axis of the outer wall surface and being provided on the connection plate.

10. The sensor carrying subassembly of claim 9, wherein said connection plate is formed on said wall by forming said wall in the direction toward the outer wall side and in a direction away from an inner space delimited by said wall.

11. The sensor carrying subassembly of claim 10, wherein said connection plate is formed by drawing said wall.

12. The sensor carrying subassembly of claim 10, wherein said connection plate is formed by deep-drawing or stretch-drawing said wall.

13. The sensor carrying subassembly of claim 9, wherein:
said connection portion of said outer wall surface overlaps said sensor connecting piece connection face at least partially radially and extends radially outwardly beyond a cylindrical outer circumferential face of said sensor connecting piece; and,
said connection material extends radially outwardly beyond said outer circumferential face of said sensor connecting piece.

14. A method of making a sensor carrying subassembly including a sensor carrying subassembly comprising: a sensor carrying member having a wall defining an outer wall side and an outer wall surface; said wall having a wall opening formed therein surrounded at said outer wall side by said outer wall surface; a sensor connecting piece secured to said outer wall surface in a region of said wall opening; said sensor connecting piece having a sensor receiving opening and defining a distal axial end disposed remote from said wall and a proximal axial end positioned near said wall; said sensor receiving opening extending through said sensor connecting piece in a direction of a sensor receiving opening longitudinal axis from said distal axial end to said proximal axial end positioned near said wall; a sensor connecting piece connection face being provided in a region of said proximal axial end of said sensor connecting piece; said sensor connecting piece connection face annularly surrounding said sensor receiving opening and being angled with respect to said sensor receiving opening longitudinal axis with radial spacing decreasing in a direction away from said distal axial end of said sensor connecting piece from said sensor receiving opening longitudinal axis; said sensor connecting piece being secured to said wall via connection material connected to said sensor connecting piece connection face and a connection portion of said outer wall surface; a connection plate formed on said wall in the region of said wall opening; and, said connection portion surrounding said wall opening and being orientated in the direction of a wall opening center axis and extending orthogonally to said wall opening center axis of the outer wall surface and being provided on the connection plate; the method comprising the step of forming the connection plate by drawing the wall.

15. The method of claim 14, wherein the drawing includes deep-drawing or stretch-drawing the wall.

16. An exhaust system comprising:
at least one sensor carrying subassembly;
said at least one sensor carrying subassembly including a sensor carrying member having a wall defining an outer wall side and an outer wall surface;
said wall having a wall opening formed therein surrounded at said outer wall side by said outer wall surface;
a sensor connecting piece secured to said outer wall surface in a region of said wall opening;
said sensor connecting piece having a sensor receiving opening and defining a distal axial end disposed remote from said wall and a proximal axial end positioned near said wall;
said sensor receiving opening extending through said sensor connecting piece in a direction of a sensor receiving opening longitudinal axis from said distal axial end to said proximal axial end positioned near said wall;
a sensor connecting piece connection face being provided in a region of said proximal axial end of said sensor connecting piece;
said sensor connecting piece connection face annularly surrounding said sensor receiving opening and being angled with respect to said sensor receiving opening longitudinal axis with radial spacing decreasing in a direction away from said distal axial end of said sensor connecting piece from said sensor receiving opening longitudinal axis; and,
said sensor connecting piece being secured to said wall via connection material connected to said sensor connecting piece connection face and a connection portion of said outer wall surface.

17. The exhaust system of claim 16, wherein said wall delimits an exhaust gas flow space; said outer wall side is orientated away from said exhaust gas flow space; and, a measurement sensor is carried on the sensor connecting piece.

18. The exhaust system of claim 17, wherein said measurement sensor is configured to provide information which represents a temperature in the region of the exhaust gas flow space or to provide information which represents a composition of exhaust gas flowing through the exhaust gas flow space.

19. The exhaust gas system of claim 16, wherein said exhaust gas system is for an internal combustion engine in a vehicle.

20. The sensor carrying subassembly of claim 1, wherein said sensor carrying subassembly is for an exhaust system of an internal combustion engine.
